(19) United States
(12) Patent Application Publication
(10) Pub. No.: US 2007/0245045 A1
(43) Pub. Date: Oct. 18, 2007

(54) Wireless data transceiver

(76) Inventor: Sidney Wu, Taipei County (TW)

Correspondence Address: Sidney Wu, 20525 Via Talavera, Yorba Linda, CA, 92887, US

(21) Appl. No.: 11/388,931

(22) Filed: Mar. 27, 2006

(51) Int. Cl. G06F 13/38

(52) U.S. Cl. 710/62

(57) ABSTRACT

A wireless data transceiver includes a case, and a circuit board mounted in the case. There are provided at least one ultra wide band (UWB) module, one antenna module, and one signal plug on the circuit board. The signal plug is projected from the case for plugging in a corresponding upstream port, which is normally a USB B type socket, on a predetermined hub. The UWB module and the antenna module are adapted to receive incoming wireless signals and transmit outgoing wireless signals, allowing the wireless data transceiver to cooperate with another data transceiver correspondingly provided on a signal processing apparatus, such as a personal computer or a notebook computer, to provide wireless signal transmission between the signal processing apparatus and various peripherals via the hub.

### FIELD OF THE INVENTION

The present invention relates to a wireless data transceiver, and more particularly to a wireless data transceiver that is adapted to connect to an upstream port on a hub to enable wireless data transmission between the signal processing apparatus, such as a personal computer or a notebook computer, and various peripherals via the hub.

### BACKGROUND OF THE INVENTION

With the prosperous development of the electronic industry, various kinds of computer peripherals have been introduced into the market. These peripherals have powerful functions and a wide range of specifications to meet the enhanced functions. For example, to achieve the targets of reliable wireless transmission, reduced volume, and increased transmission speed, universal serial bus (USB) connectors with different specifications, such as USB A, USB B, USB mini B, and IEEE 1394 type connectors, are currently available in the market. However, in consideration of cost factor and limits in circuit design, most existing signal processing apparatus, such as personal computer (PC), notebook computer (NB), etc., are only provided with the most popular USB A type socket. And, the USB A type sockets provided on the general signal processing apparatus are insufficient in number for connection of so many different peripherals to the signal processing apparatus. Therefore, a hub having a plurality of USB sockets is utilized to interconnect the large quantity of peripherals with the signal processing apparatus, so as to satisfy the general consumers' demands.

Currently, when a hub 3 is utilized to connect various peripherals 6 to a signal processing apparatus 4, including PC and NB, the signal processing apparatus 4 is connected to the hub 3 via a cable 5, as shown in FIG. 1. The hub 3 is provided with a plurality of downstream ports 32, which are usually USB A type sockets for corresponding USB A type plugs on various peripherals 6, including printer 61, scanner 62, digital camera 63, keyboard 64, etc., to plug in. The hub 3 also includes an upstream port 31, which is a USB B type socket. However, the signal processing apparatus 4, such as PC or NB, has a connecting port 41 that is a USB A type socket. Therefore, to enable signal transmission between the signal processing apparatus 4 and the hub 3, the cable 5 for connecting the hub 3 to the signal processing apparatus 4 must have an end in the form of a USB A type plug 51 for plugging in the USB A type socket 41 on the signal processing apparatus 4, and another end in the form of a USB B type plug 52 for plugging in the USB B type upstream port 31 on the hub 3.

With the fact wireless transmission has gradually become the main stream in the data transmission between information products, various wireless transmission specifications and systems for using between the peripherals 6 and the signal processing apparatus 4 have been developed. Such wireless transmission system mainly includes a data transceiver 42 having an ultra wide band (UWB) module and a USB A type plug. The data transceiver 42 is connected to the signal processing apparatus 4 by plugging the USB A type plug in the USB A type socket 41 on the signal processing apparatus 4, so as to receive wireless signals transmitted from the peripherals 6 that also have a UWB module provided therein, and thereby achieve the function of wireless signal transmission between the signal processing apparatus 4 and the peripherals 6.

However, the above-mentioned data transceiver 42 having a USB A type plug could not be used with the hub 3 having a USB B type upstream port 32, and therefore has limited application. Meanwhile, since the UWB module is very expensive in terms of the currently available developing and manufacturing techniques, it is uneasy to widely use the UWB module in all kinds of peripherals 6. Thus, it is an important issue to achieve the convenient wireless signal transmission between the peripherals 6 and the signal processing apparatus 4 at the lowest possible cost.

It is therefore tried by the inventor to develop a wireless data transceiver to break through the bottleneck in the use of the conventional data transceiver having UWB module with the hub.

### SUMMARY OF THE INVENTION

A primary object of the present invention is to provide a wireless data transceiver to effectively reduce the cost of equipment for wireless signal transmission between a signal processing apparatus and various peripherals thereof, so that the signal processing apparatus and the peripherals are more convenient for use.

To achieve the above and other objects, the wireless data transceiver of the present invention includes a case, and a circuit board mounted in the case. There are provided at least one ultra wide band (UWB) module, one antenna module, and one signal plug on the circuit board. The signal plug is projected from the case for plugging in a corresponding upstream port, which is normally a USB B type socket, on a predetermined hub. The UWB module and the antenna module are adapted to receive incoming wireless signals and transmit outgoing wireless signals, allowing the wireless data transceiver to cooperate with another data transceiver correspondingly provided on a signal processing apparatus, such as a personal computer or a notebook computer, to provide wireless signal transmission between the signal processing apparatus and various peripherals via the hub.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional way of connecting various peripherals to a signal processing apparatus via a hub, wherein the hub is connected to the signal processing apparatus using a USB cable;

FIG. 2 is an assembled perspective view of a wireless data transceiver according to the present invention;

FIG. 3 is an exploded view of FIG. 2; and

FIG. 4 shows an example of using the wireless data transceiver of the present invention in the connection of various peripherals to a signal processing apparatus via a hub.

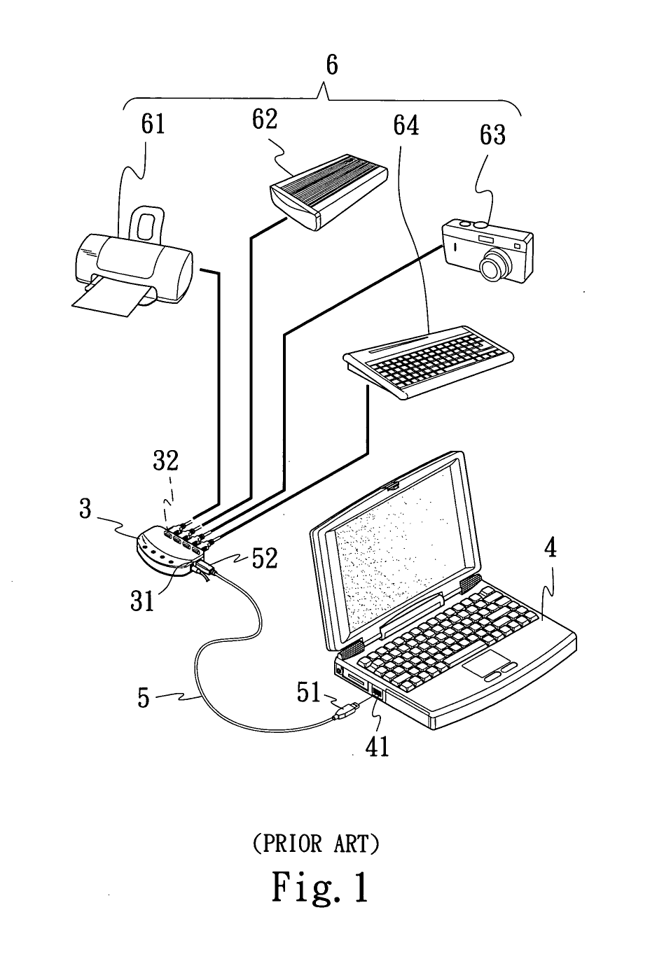

### DETAILED DESCRIPTION OF THE PREFERRED EMBODIMENTS

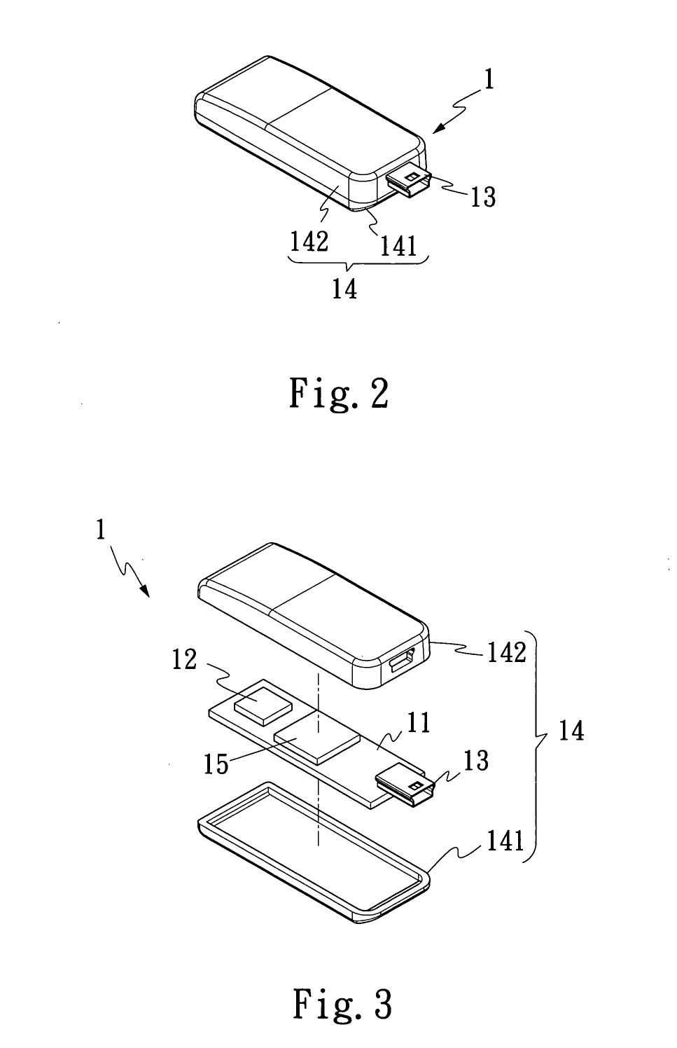

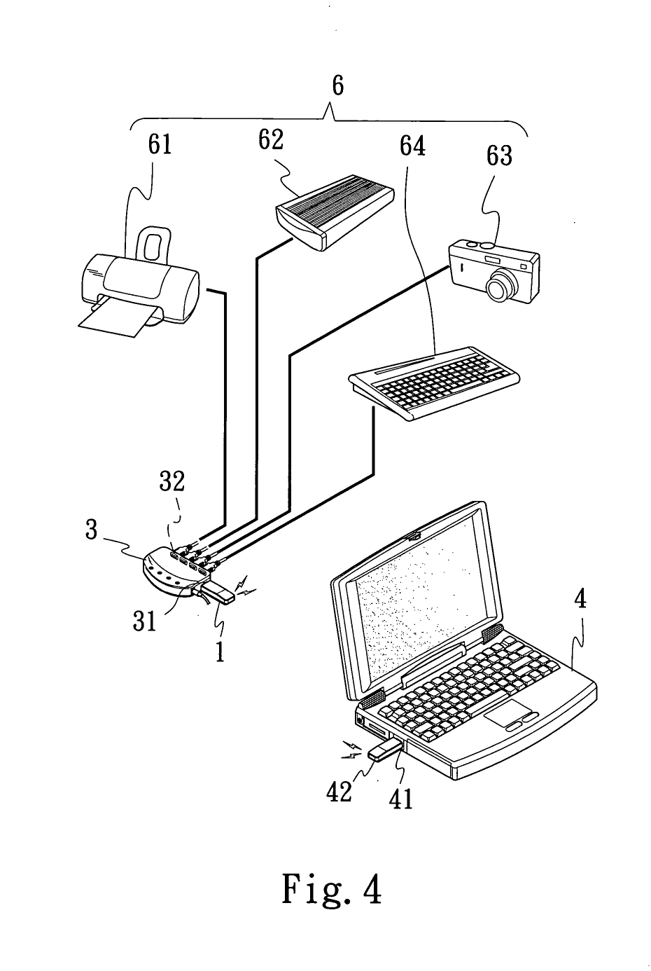

Please refer to FIGS. 2 and 3 that are assembled and exploded perspective views, respectively, of a wireless data transceiver 1 according to an embodiment of the present invention, and to FIG. 4 that shows an example of using the wireless data transceiver 1 of the present invention in the connection of various peripherals 6 to a signal processing apparatus 4. As shown, the wireless data transceiver 1 of the present invention includes a circuit board 11, a signal plug 13, and a case 14. The case 14 consists of a seat 141 and a cover 142 that could be fitly closed to each other to define an inner space for receiving the circuit board 11 therein. On the circuit board 11, there are provided at least one antenna module 12 and one ultra wide band (UWB) module 15. The signal plug 13 is located at an edge of the circuit board 11 to project from the case 14. The signal plug 13 has a specification corresponding to that of an upstream port 31 on a hub 3, to which the signal plug 13 is to be connected. For instance, when the upstream port of the hub 3 is a USB B type socket, the signal plug 13 is also produced as a USB B type plug for plugging in the USB B type upstream port 31 to electrically connect to the hub 3; and when the upstream port 31 is a socket of other specific specification, such as a USB A type socket, a USB mini B type socket, or an IEEE 1394 socket, the signal plug 13 is produced as a corresponding USB A type socket, USB mini B type socket, or IEEE 1394 plug to advantageously connect to the hub 3.

To use the wireless data transceiver 1 of the present invention in the connection of various peripherals 6 to the signal processing apparatus 4 via the hub 3, simply plug the signal plug 13 in the upstream port 31 on the hub 3, and connect the various peripherals 6, such as printer 61, scanner 62, digital camera 63, keyboard 64, etc. to a plurality of downstream ports 32 on the hub 3 using cables. Meanwhile, another data transceiver 42 having a USB A type plug and being internally provided with UWB module and antenna module similar to those in the data transceiver 1 is plugged in a USB A type socket 41 on the signal processing apparatus 4, which may be a PC, NB, or the like. The UWB modules in the two data transceivers 1, 42 receive incoming wireless signals or transmit outgoing wireless signals via respective antenna modules, and thereby provide a wireless signal transmission between the signal processing apparatus 4 and the hub 3, allowing the signal processing apparatus 4 to wirelessly connected to the various peripherals 6 via the hub 3. The signal processing apparatus 4 and the peripherals 6 are therefore more conveniently for use.

What is claimed is:

1. A wireless data transceiver, comprising a case, and a circuit board mounted in said case and having at least one ultra wide band (UWB) module and one antenna module provided thereon; said wireless data transceiver being characterized in that:
said circuit board further includes a signal plug projected from said case; and that said signal plug is adapted to plug in an upstream port on a hub, so as to cooperate with another data transceiver correspondingly provided on a predetermined signal processing apparatus to provide wireless signal transmission between said signal processing apparatus and said hub.

2. The wireless data transceiver as claimed in claim 1, wherein said signal plug is a USB B type plug.

3. The wireless data transceiver as claimed in claim 1, wherein said signal plug is selected from the group consisting of USB A type plug, USB B type plug, USB mini B type plug, and IEEE 1394 plug.
